(19) United States
(12) Patent Application Publication
(10) Pub. No.: US 2008/0251102 A1
(43) Pub. Date: Oct. 16, 2008

(54) CLEANING DEVICE FOR ENDOSCOPIC DEVICES

(75) Inventors: Scott G. Haack, Massillon, OH (US); Christopher J. Kaye, Concord, OH (US); Dean J. Secrest, Concord, OH (US)

Correspondence Address: CALFEE HALTER & GRISWOLD, LLP, 800 SUPERIOR AVENUE, SUITE 1400, CLEVELAND, OH, 44114, US

(73) Assignee: US ENDOSCOPY GROUP, INC., Mentor, OH (US)

(21) Appl. No.: 12/102,435

(22) Filed: Apr. 14, 2008

Related U.S. Application Data
(60) Provisional application No. 60/911,672, filed on Apr. 13, 2007.

(51) Int. Cl. B08B 9/023; B08B 1/00

(52) U.S. Cl. 134/6; 15/104.04; 15/104.93

(57) ABSTRACT

A device for cleaning an endoscopic device is disclosed. The device has a flexible sleeve movable between a collapsed position and an extended position. The sleeve has an opening at its proximal end. A cleaning tool is disposed within the sleeve. Further, cleaning fluid is included within the sleeve. A method of using the device to clean an endoscopic device is also disclosed.

### CROSS REFERENCE TO RELATED APPLICATIONS

This non-provisional application claims the benefit of U.S. Provisional Patent Application No. 60/911,672, entitled “Cleaning Tool for Endoscopic Devices,” filed Apr. 13, 2007, which is hereby incorporated in its entirety to the extent it is not conflicting with the present application.

### FIELD OF THE INVENTION

The invention relates to a cleaning device and to a cleaning device for cleaning endoscopic medical devices.

### BACKGROUND OF THE INVENTION

Endoscopes are well-known in the art and are commonly used for numerous medical procedures. One exemplary procedure is removing polyps, lesions or other types of targeted tissue from the gastrointestinal wall of a human subject. During such procedures, the exterior and interior portions of the endoscope are typically contaminated.

Endoscopes are often sterilized and reused. This reprocessing is necessary due to the significant cost of the endoscope. However, the endoscope is generally not reprocessed at the patient's bedside directly after use. Instead, the endoscope is stored in a reprocessing room until it can be properly cleaned and sterilized. Therefore, many doctors and nurses pre-clean the endoscope prior to storage for reprocessing. Pre-cleaning removes contamination and debris from the exterior and interior portions of the endoscope. The pre-cleaning allows the endoscope to stay moist, prohibiting the debris and contaminants on the endoscope from drying out. Further, pre-cleaning limits the exposure of medical personnel to the contaminated endoscope.

In one conventional pre-cleaning technique, a nurse will first wipe the insertion tube using gauze saturated with enzymatic detergent. Next, the nurse aspirates enzymatic detergent through the entire biopsy/suction channel system, alternating the suctioning of air and detergent to create agitation. The nurse must then purge the air and water channels using a water bottle, air pump, and a valve to expel fluid/debris from the air and water channels. In addition, the nurse may have to purge any special feature channels of the endoscope, such as a water jet, exposed elevator, etc. Finally, the nurse must place the contaminated endoscope in a bin having a cover, a bag, or other suitable container that will limit the endoscope's exposure to the air during transport to the reprocessing room. The endoscope may sit in the reprocessing room for long periods of time before formal reprocessing. As a result, debris and contaminants on the endoscope dry, making the endoscope difficult to reprocess. Therefore, keeping the endoscope moist after use and prior to formal reprocessing is desired.

As outlined above, several drawbacks exist with known processes for manually reprocessing, or pre-cleaning, an endoscope. The processes may be complicated, time consuming, and unsanitary. Therefore, a need exists in the art for a bedside enzymatic cleaning device for endoscopes that is easy to use, quick, and more conducive to a sanitary environment.

### BRIEF DESCRIPTION OF THE DRAWINGS

Further features and advantages of this invention will become apparent from the following detailed description made with reference to the accompanying drawings.

FIG. 1 is a perspective view of a cleaning device according to an embodiment of the invention, wherein the cleaning device is in a ready-to-use condition;

FIG. 2 is a front partial cross sectional view of the cleaning device depicted in FIG. 1, wherein an endoscopic device is partially inserted into the rolled cleaning device;

FIG. 3 is a perspective view, and a partial cross sectional view, of the cleaning device depicted in FIG. 1, wherein an endoscopic device is fully inserted into the extended cleaning device;

FIG. 4 is a perspective view of a cleaning device according to another embodiment of the invention, wherein an endoscopic device is fully inserted into an extended cleaning device and the cleaning device includes a container;

FIG. 5 is a perspective view of the cleaning device depicted in FIG. 4, wherein the endoscopic device is packaged within the container of the cleaning device;

FIG. 6A is a front view of the cleaning device depicted in FIG. 4, wherein the cleaning device is extended and unfolded;

FIG. 6B is a front view of the cleaning device depicted in FIG. 4, wherein the cleaning device is extended and partially folded;

FIG. 6C is a front view of the cleaning device depicted in FIG. 4, wherein the cleaning device is extended and folded;

FIG. 6D is a front view of the cleaning device depicted in FIG. 4, wherein the cleaning device is rolled;

FIG. 7 is a perspective view of a cleaning device according to another embodiment of the invention, wherein the cleaning device is collapsed;

FIG. 8 is a perspective view of the cleaning device depicted in FIG. 7, wherein an endoscopic device is inserted into the extended cleaning device;

FIG. 9 is a front cross sectional view of a cleaning device according to another embodiment of the invention, wherein a removable cleaning tool is illustrated and remote from the cleaning device;

FIG. 10 is a front cross sectional view of a cleaning device according to another embodiment of the invention, wherein a removable cleaning tool is packaged within the cleaning device;

FIGS. 11A and 11B are perspective views of two exemplary removable cleaning tools usable with the cleaning device depicted in FIG. 10;

FIG. 12 is a front cross sectional view of a cleaning device according to another embodiment of the invention, wherein a sleeve of the cleaning device is attached to a container having a suction cup;

FIG. 13 is a front cross sectional view of a cleaning device according to another embodiment of the invention, wherein a sleeve of the cleaning device is attached to a lid of a container having a suction cup;

FIGS. 14A-14C are perspective views of a cleaning device according to another embodiment of the invention, wherein a lid of the cleaning device has a suction cup;

FIG. 15 is a front cross sectional view of a cleaning device according to another embodiment of the invention, wherein a suction cup is integrally formed with the bottom of a container;

FIG. 16A is a front cross sectional view of a cleaning device according to another embodiment of the invention, wherein a sleeve of the cleaning device is attached to the inside bottom of a container and the cleaning device is in a ready-to-use condition;

FIG. 16B is a front cross sectional view of the cleaning device of FIG. 16A, wherein the cleaning device is in an extended condition;

FIG. 17A is a perspective view of a cleaning device according to another embodiment of the invention, wherein the cleaning device includes a mounting component; and

FIG. 17B is a perspective view of the mounting component of FIG. 17A.

### DETAILED DESCRIPTION OF THE INVENTION

This Detailed Description of the Invention merely describes embodiments of the invention and is not intended to limit the scope of the specification or claims in any way. Indeed, the inventions as described by the claims are broader than and unlimited by the preferred embodiments, and the terms used in the claims have their full and ordinary meaning.

The invention will be described for use with an endoscopic device, such as an endoscope having an instrument channel. It should be understood that this is for exemplary purposes only and the invention can be applied to a wide variety of applications. Further, the invention will be described with the use of an enzymatic detergent. Similarly, this is for exemplary purposes only and other types of cleaners, such as for example soap and water, may be used with the invention.

A bed side cleaning device for endoscopic devices, such as an endoscope having an instrument channel, is disclosed. For example, the cleaning device may include a cleaning tool and enzymatic detergent contained in one package. The cleaning tool is impregnated with the enzymatic detergent and has a slit, or hole, for the endoscopic device, such as the elongated tube of an endoscope, to pass through. Further, the cleaning device may have a reservoir of enzymatic solution located below or above the cleaning tool. In one embodiment, the package is a flexible low density polyethylene container, such as a bag or sleeve. The bag is extendable to house at least a portion of the endoscopic device and capture any fluid or debris. Further, the extended bag keeps the endoscopic device moist during transport, prohibiting the endoscopic device from drying out. In another embodiment, the package includes a bag having one end attached to the interior of a sealable container, such as a zipper bag. This embodiment allows the entire endoscopic device, including the control head and umbilicus of an endoscope, to be housed in the zipper bag. However, many different package types, shapes, sizes, materials, and styles and equipment styles and configurations are possible in the practice of this invention. In still another embodiment, the distal end of the cleaning device is attached to a container, or reservoir, having a sponge and a suction cup. This embodiment allows the distal end of the cleaning device to be anchored, such as to a floor, assisting in the insertion and removal of the endoscopic device. Further, the sponge prohibits damage to the optics at the distal end of the endoscopic device.

In order to use the cleaning device, the distal, or insertion, end of the endoscopic device is inserted through the top opening of the cleaning device into an encased cleaning tool. The endoscopic device is then pushed through the cleaning tool to clean the exterior of the endoscopic device. To better remove debris and contaminants, manual pressure may be applied to the exterior of the cleaning tool while the endoscopic device is passing through the cleaning tool. Finally, much of the remaining detergent in the package of the cleaning device is suctioned through the endoscopic device to clean the interior channels.

The invention offers numerous improvements over conventional pre-cleaning techniques. The cleaning device allows a nurse to quickly and easily clean and store an endoscopic device in one convenient package without creating an excessive unsanitary environment. The package may be transparent to ensure the endoscopic device is properly cleaned. Further, the cleaning tool is immersed in the enzymatic detergent to ensure it is moist and ready to use. Finally, the cleaning device encases the endoscopic device after cleaning to keep the endoscopic device moist during transport or storage. As a result, a nurse does not have to use a separate container to prohibit the endoscopic device from drying out. Further, the cleaning device may be collapsed, folded, and/or rolled for disposal to reduce the volume of biological waste and cost of disposal.

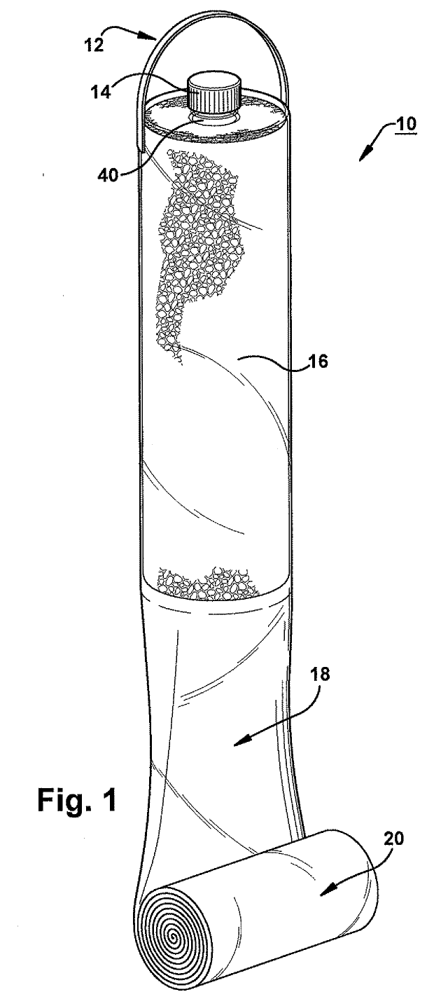

Referring now to the drawings, FIGS. 1-3 illustrate a cleaning device 10 according to an embodiment of the invention. The exemplary cleaning device 10 depicted in the figures includes a tubular sleeve 20, or bag, having a cleaning tool 16, a reservoir 18, an opening 40, a strap 12, or hook, and a cap 14. The strap 12 is useful for storage of the cleaning device 10 before or after use and/or anchoring the cleaning device 10 during use. In the depicted embodiment, the tubular sleeve 20 is a flexible bag that may be rolled. The sleeve 20 is made from low density polyethylene. However other flexible materials may be used. Further, the sleeve 20 may be transparent. The transparency of the sleeve 20 allows the user, such as a nurse, to ensure the endoscopic device is properly cleaned. As shown, the cleaning tool 16 is a sponge. However, the cleaning tool 16 may be any suitable cleaning tool known in the art, such as for example a cloth rag or paper like towel. Any type of suitable container may be substituted for the sleeve 20.

FIG. 1 depicts the cleaning device 10 in a ready-to-use condition. In this condition, the cap is attached to the opening 40 to prohibit spillage of the enzymatic detergent. The cap 14 may be any type of cap or lid capable of prohibiting the enzymatic detergent from spilling. In the depicted embodiment, the cap 14 is threaded.

As shown in FIG. 1, the cap 14 and the sleeve 20 attach to the opening 40. The sleeve 20 may be attached to the opening 40 by a variety of means known to one skilled in the art, such as for example, with an elastic band, adhesive, or heat sealing. Further, the opening 40 may be made from any suitable material capable of supporting the cap 14 and sleeve 20, such as for example, plastic or metal. In the depicted embodiment, the opening 40 includes threads capable of mating with the threaded cap 14.

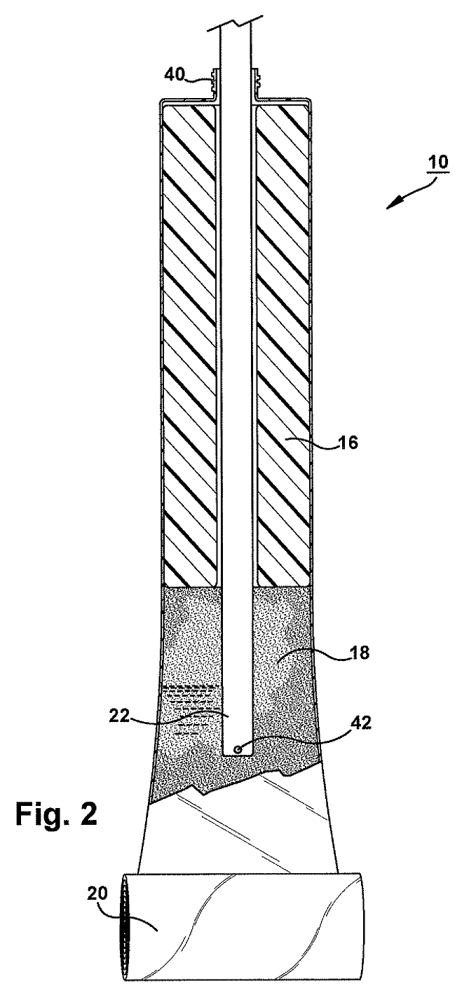

As depicted in FIG. 2, the sponge 16 is placed at the proximal end of the sleeve 20 and the distal end of the sleeve 20 is rolled to just below the sponge 16. The portion of the sleeve 20 between the sponge 16 and the rolled distal end of the sleeve 20 creates a reservoir 18. As shown, the sleeve 20 is filled with enzymatic detergent, impregnating the sponge 16 and filling the reservoir 18 with the detergent. It should be apparent to those with ordinary skill in the art that the reservoir location may vary, such as for example, between the opening and the sponge.

FIG. 2 illustrates the cleaning device 10 in use. As shown, the distal, or insertion, end of the endoscopic device 22 is inserted through the top opening 40 and encased sponge 16 of the cleaning device 10 into the reservoir 18 of enzymatic detergent. Pushing the endoscopic device 22 through the sponge 16 impregnated with enzymatic detergent removes debris and contaminants from the exterior of the device 22. After insertion into the reservoir 18, the enzymatic detergent in the reservoir 18 of the cleaning device 10 may be suctioned through an opening 42 located towards the distal end of the endoscopic device 22. Suctioning the enzymatic detergent through the interior channels of the device removes debris and contaminants that may have collected in the channels. The detergent may be suctioned through the opening 42 by a variety of means known to one skilled in the art, such as for example, by using a vacuum source to suction the fluid through the channels from the proximal end of the endoscopic device 22.

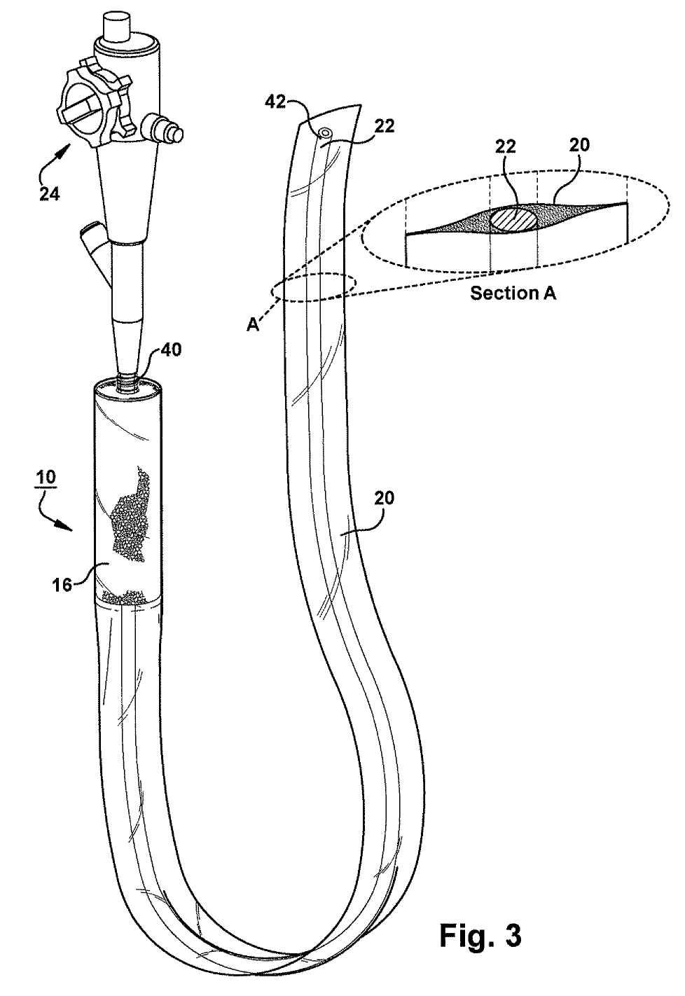

FIG. 3 illustrates the cleaning device 10 with the sleeve 20 extended and the endoscopic device 22 fully inserted in the sleeve 20. In this condition, the exterior of the endoscopic device 22 has already passed through the sponge 16, removing debris or contaminants from the exterior of the device 22. In addition, much of the enzymatic detergent trapped in the reservoir 18 (shown in FIGS. 1-2) has been suctioned through the channels of the endoscopic device 22, removing debris or contaminants from the channels. As explained more fully below, the exterior of the endoscopic device 22 is coated with detergent to prohibit the device 22 from drying out and to begin the process of breaking down biological contamination. At this point, the cleaning device 10 and endoscopic device may be safely transported or stored until further reprocessing.

The sleeve 20 of the cleaning device 10 may be a variety of lengths and sizes to fit various types of endoscopic devices. Similarly, the size and shape of the sponge 16 and amount of enzymatic detergent in the sleeve 20 may vary according to the endoscopic device. As shown in FIG. 3, the sleeve 20 may be generally the same length as the endoscopic device 22, but can be of any size to accommodate the endoscopic device 22. The cleaning device 10 remains attached to the endoscopic device 22 during transport and storage. As shown in FIG. 3, the control head 24 and umbilicus (not shown) of an endoscope are outside the exemplary cleaning device 10.

The enzymatic detergent trapped in the reservoir 18 (shown in FIGS. 1-2) and not already filtered through the channels of the device 22 will move towards the distal end of the sleeve 20 as the sleeve 20 is extended, coating the interior walls of the sleeve 20. Once the sleeve 20 is extended, the remaining length of the endoscopic device 22 is inserted through the sponge 16 and into the sleeve 20. As shown in Section A of FIG. 3, the interior walls of the sleeve 20 wrap around the exterior of the endoscopic device 22. As such, the coating of enzymatic detergent on the interior walls of the sleeve 20 will transfer to the exterior of the endoscopic device 22. This coating of detergent, along with any detergent applied to the exterior of the device 22 from the sponge 16, helps prohibit the endoscopic device 22 from drying out during transport and storage. Upon removal of the endoscopic device 22 from the cleaning device 10, the exterior of the device 22 is again cleaned by the sponge 16 as it passes through the sponge 16 in the opposite direction. Also, remaining debris or contaminants inside the interior channels of the device 22 may be expelled into the sleeve 20. The cleaning device 10 may, or may not, then be capped.

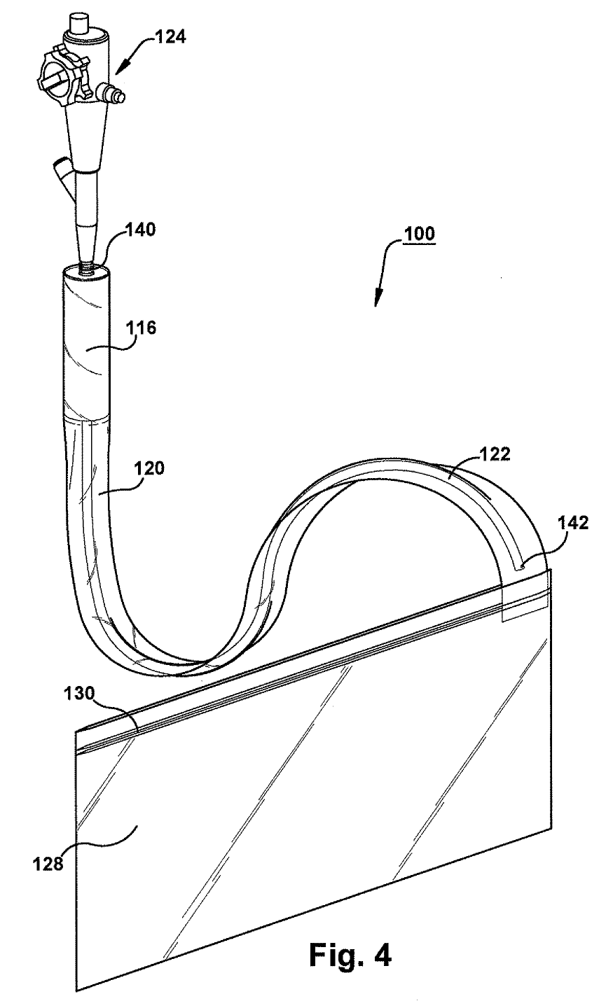

FIGS. 4-6D illustrate a cleaning device 100 according to another embodiment of the invention. The cleaning device 100 shown in FIGS. 4-6D is similar to the cleaning device 10 shown in FIGS. 1-3. However, in this embodiment, the cleaning device 100 includes a container 128, such as a sealable bag, for housing the entire endoscopic device 122, such as an endoscope, including any portion of the device 122 outside the sleeve 120 of the cleaning device 100, such as the control head 124 and umbilicus (not shown) of the endoscope.

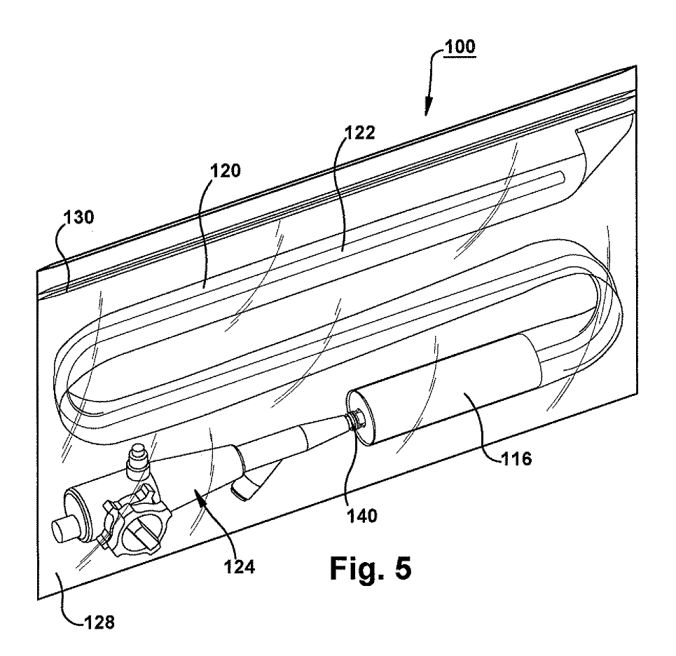

The container 128 may be made out of any material capable of supporting an endoscopic device, such as plastic or nylon. Further, the container 128 may be transparent so that the user can readily see and identify the type of endoscopic device in the container 128. The container 128 may be sealable. The exemplary container 128 is sealed by a zipper 130, as best shown in FIGS. 4-5. However, any suitable means known in the art, such as for example folds, snaps, buttons, heat sealing, or tie strings, may be used to seal the container 128.

As depicted in FIGS. 4-5, the sleeve 120 of the cleaning device 100 is attached to the interior of the container 128. In the current embodiment, the distal end of the sleeve 120 is attached to the interior of one end of the container 128. The sleeve 120 may be attached to the container 128 by various means known in the art, such as for example with stitching or an adhesive. Further, in certain embodiments, only one half of the sleeve 120 is attached to the interior of the container 128, forming a pocket between the interior wall of the sleeve 120 and interior of the container 128. Finally, in still other embodiments, the sleeve 120 may be removably attached to the interior of the container 128, for example with Velcro® or tape.

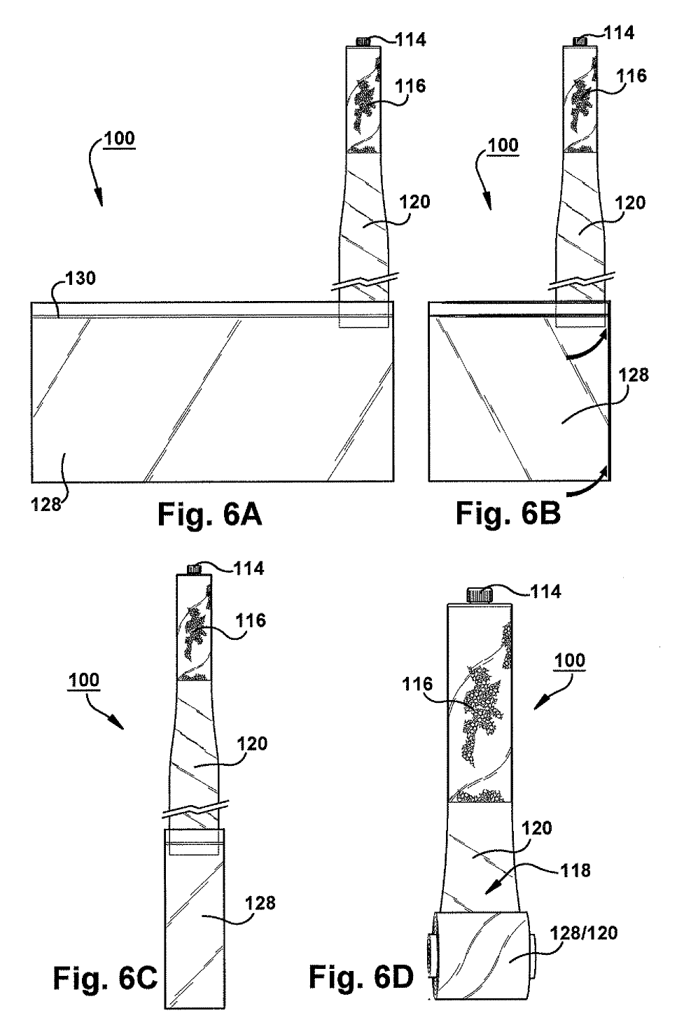

Similar to the cleaning device 10 depicted in FIGS. 1-3, the distal, or insertion, end of the endoscopic device 122 is inserted through the top opening 140 of the cleaning device 100 and through the cleaning tool 116, or sponge, to clean the exterior of the endoscopic device 122. In addition, in its folded and rolled condition (shown in FIG. 6D), detergent in the reservoir 118 of the cleaning device 100 is filtered through an opening 142 located toward the distal end of the endoscopic device 122 to clean the channels. Further, similar to the cleaning device 10 depicted in FIGS. 1-3, the enzymatic detergent trapped in the reservoir 118 (shown in FIG. 6D) and not already filtered through the channels of the device 122 will move towards the distal end of the sleeve 120 as the sleeve 120 is extended, coating the interior walls of the sleeve 120. This coating of detergent, along with any detergent applied to the exterior of the device 122 from the sponge 116, helps prohibit the endoscopic device 122 from drying out during transport and storage.

In the exemplary cleaning device 10 shown in FIGS. 1-3, any portion of the endoscopic device 22, such as an endoscope, outside the sleeve 20, such as the control head 124 and umbilicus (not shown), remain outside the cleaning device 10. However, in the exemplary cleaning device 100 shown in FIGS. 4-6D, the extended sleeve 120 housing the endoscopic device 122 may be folded (or removed from the container if removably attached) and stored in the container 128, or zipper bag (as shown in FIG. 5). In this embodiment, the endoscopic device 122 including any portion of the device 122 outside the sleeve 120 of the cleaning device 100 are packaged together within the container 128 for transport and storage.

FIGS. 6A-6D depict how the sleeve 120 and container 128 of the exemplary cleaning device 100 may be folded and rolled prior to use. More specifically, FIGS. 6A-6D sequentially illustrate how the cleaning device 100 may be folded and rolled into a ready-to-use condition, similar to the condition of the exemplary cleaning device 10 in FIGS. 1-2. First, FIG. 6A depicts the cleaning device 100 in an extended and unfolded condition. Second, FIG. 6B depicts the container 128 folded over itself towards the end of the container 128 to which the sleeve 120 is attached. FIG. 6C depicts the container 128 folded again such that the sleeve 120 and the folded container 128 are generally the same width and may be rolled together in a direction toward the sponge 116. Finally, FIG. 6D depicts the container 128 and sleeve 120 rolled together such that the distal end of the sleeve 120 and the container 128 are rolled to just below the sponge 116. The portion of the sleeve 120 between the sponge 116 and the rolled distal end of the sleeve 120 and the container 128 creates a reservoir 118. As shown, the sleeve 120 may be filled with enzymatic detergent, impregnating the sponge 116 and filling the reservoir 118 with the detergent.

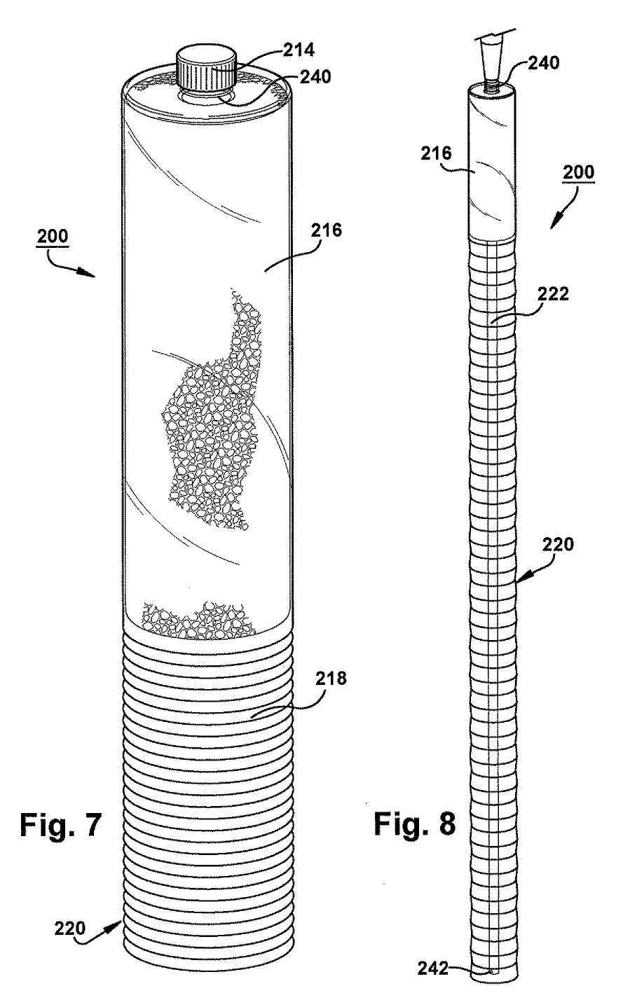

FIGS. 7-8 illustrate a cleaning device 200 according to another embodiment of the invention. The cleaning device 200 shown in FIGS. 7-8 has some similarity to the cleaning device 10 shown in FIGS. 1-3. However, in this embodiment, the sleeve 220 of the cleaning device 200 is collapsible tubing. The tubing may be made from any suitable material known in the art, such as rubber or plastic. The flexible tubing of the sleeve 220 may be collapsed (as shown in FIG. 7) or extended (as shown in FIG. 8). In certain embodiments, the cleaning device 200 also includes a securing device, such as an elastic band, strap, or fastener, that holds the sleeve 220 in the collapsed condition.

Similar to the cleaning device 10 depicted in FIGS. 1-3, the distal, or insertion, end of the endoscopic device 222 (shown in FIG. 8) is inserted through the top opening 240 of the cleaning device 200 and through the cleaning tool 216 to clean the exterior of the endoscopic device 222. In addition, in its collapsed condition (shown in FIG. 7), the collapsed flexible tubing creates a reservoir 218 that may be filled with enzymatic detergent. Detergent in the reservoir 218 is suctioned through an internal opening 242 located toward the distal end of the endoscopic device 222 to clean the channels of the endoscope. Further, similar to the cleaning device 10 depicted in FIGS. 1-3, the enzymatic detergent trapped in the reservoir 218 (shown in FIG. 7) and not already suctioned through the channels of the device 222, will move towards the distal end of the sleeve 220 as the sleeve 220 is extended (as shown in FIG. 8), coating the interior walls of the sleeve 220. This coating of detergent, along with any detergent applied to the exterior of the device 222 from the cleaning tool 216, helps prohibit the endoscopic device 222 from drying out during transport and storage.

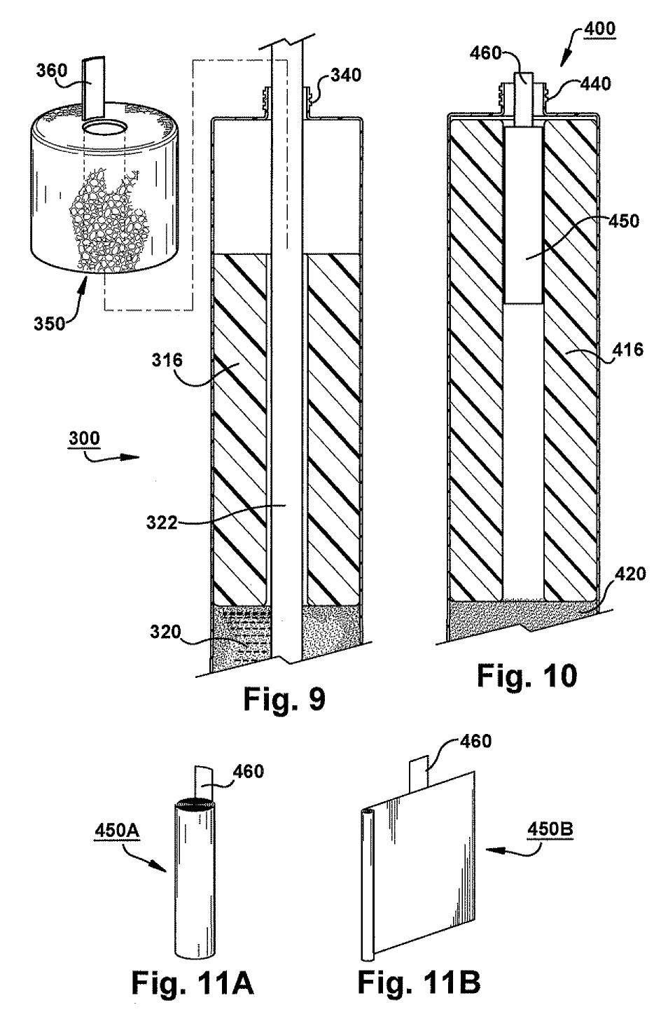

FIG. 9 illustrates a cleaning device 300 according to another embodiment of the invention. The cleaning device 300 shown in FIG. 9 has some similarity to the cleaning device 10 shown in FIGS. 1-3. However, in this embodiment, the cleaning device 300 includes a removable cleaning tool 350. As shown, the removable cleaning tool 350 is a removable sponge. However, the removable cleaning tool 350 may be any suitable cleaning tool known in the art, such as for example a cloth rag or paper like towel. Similar to the sponge 16 in FIGS. 1-3, the removable sponge 350 may be impregnated with enzymatic detergent. As illustrated in FIG. 9, the removable sponge 350 is coaxially packed with the main sponge 316 within the sleeve 320. The removable sponge 350 may be removed from the cleaning device 300 through the opening 340. The removable sponge 350 may have a tab 360 attached to the sponge 350 to facilitate removal of the sponge 350 through the opening 340 of the cleaning device 300. However, any suitable removing means known in the art may be used, such as a string, ribbon, or the like.

As illustrated in FIG. 9, the removable sponge 350 has a similar shape as the main sponge 316, with a hole through the center. However, the removable sponge 350 may be a variety of shapes, sizes, and configurations. For example, in certain embodiments, the removable sponge does not have a hole through the center (see FIGS. 10-11B). In other embodiments, the removable sponge is folded or wrapped (see FIG. 11B). The folded sponge may be unfolded or unwrapped after removal from the cleaning tool, providing the removed sponge more surface area for cleaning.

Generally, the removable sponge 350 is removed before the distal, or insertion, end of the endoscopic device 322 (shown in FIG. 9) is inserted through the top opening 340 of the cleaning device 300 and through the main sponge 316 to clean the exterior of the endoscopic device 322. The removable sponge 350 is often used to clean any portion of the endoscopic device 322, such as an endoscope, that remains outside the sleeve 320, such as the control head and umbilicus. Although the control head and umbilicus portions of the endoscope are not typically contaminated because they generally do not contact the patient, the doctor or nurse's gloved hand may contaminate the control head or umbilicus. Regardless, the removable sponge 350 may be used for other cleaning purposes, such as to clean other equipment or the doctor's hands.

FIGS. 10-11B illustrate a cleaning device 400 according to another embodiment of the invention. The cleaning device 400 shown in FIGS. 10-11B is similar to the cleaning device 300 shown in FIG. 9. In this embodiment, however, the removable cleaning tool 450, or removable sponge, is packed within the lumen of the main sponge 416. In this embodiment, the removable sponge 450 may be any length capable of fitting within the cleaning device 400. For example, the removable sponge 450 may extend out the bottom of the main sponge 416 and into the reservoir 418 of enzymatic fluid. Similarly, the removable sponge 450 may be any diameter capable of fitting through the opening 440 of the cleaning device 400 and lumen of the main sponge 416. The removable sponge 450 may also be impregnated with enzymatic detergent. Further, the removable sponge 450 comprises a tab 460 attached to the sponge 450 to facilitate removal of the sponge 450 through the opening 440 of the cleaning device 400. However, any suitable removing means known in the art may be used, such as a string, ribbon, or the like.

As depicted in FIGS. 10-11B, the removable sponge 450 may be a variety of shapes, sizes, and configurations. For example, a removable sponge 450A is generally the same shape as the lumen of the main sponge 416. In another example, removable sponge 450B is folded or wrapped. As shown in FIG. 11B, the folded sponge 450B may be unfolded or unwrapped after removal from the cleaning device 400, providing the removed sponge 450B more surface area for cleaning. In still other embodiments, the removable sponge is a different material (not shown), such as for example a cloth rag or paper like towel.

Similar to the cleaning device 300 shown in FIG. 9, the removable sponge 450 is removed before the distal, or insertion, end of the endoscopic device is inserted through the top opening 440 and main sponge 416 of the cleaning device 400. In addition, the removable sponge 450 of the cleaning device 400 may be used to clean and sterilize the portion of the endoscopic device that remains outside the sleeve 420. However, the removable sponge 450 may also be used for other cleaning purposes, such as to clean other equipment or the hands of the user.

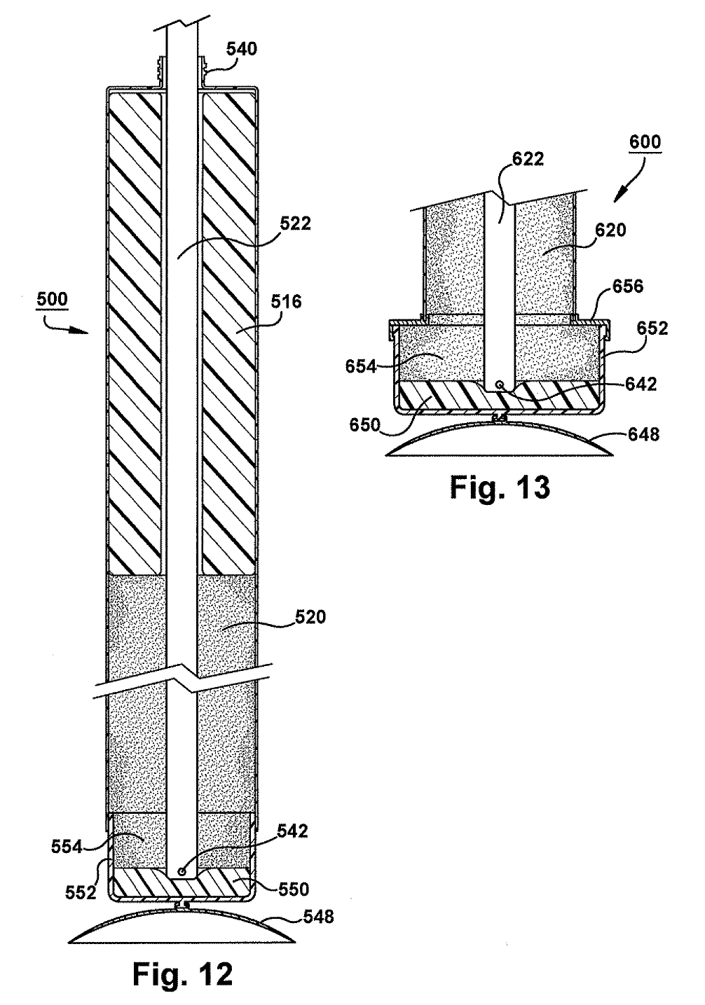

FIG. 12 illustrates a cleaning device 500. The distal end of a collapsible tubing or sleeve 520, for example a soft polyethylene (PE) sheath, is attached to a container 552. The container 552 may be molded and made from any suitable material known in the art, such as polyethylene (PE). The container 552 has a sponge 550, or other soft material such as cloth or foam, lining the bottom of the container. The sponge 550 prohibits damage to the optics at the distal end of the endoscopic device 522, for example, during insertion of the endoscopic device into the sleeve 520. In certain embodiments, the container 552 is made from a soft material, such as a thermoplastic elastomer (TPE). In these embodiments, the container surface itself prohibits damage to the optics at the distal end of the endoscopic device 522. In other embodiments, the proximal end of the sleeve, or collapsible tubing, may be attached to a handle type feature that may not contain a sponge. Further, a removable sponge may be included within the container to clean various portions of the endoscopic device, or for other cleaning purposes.

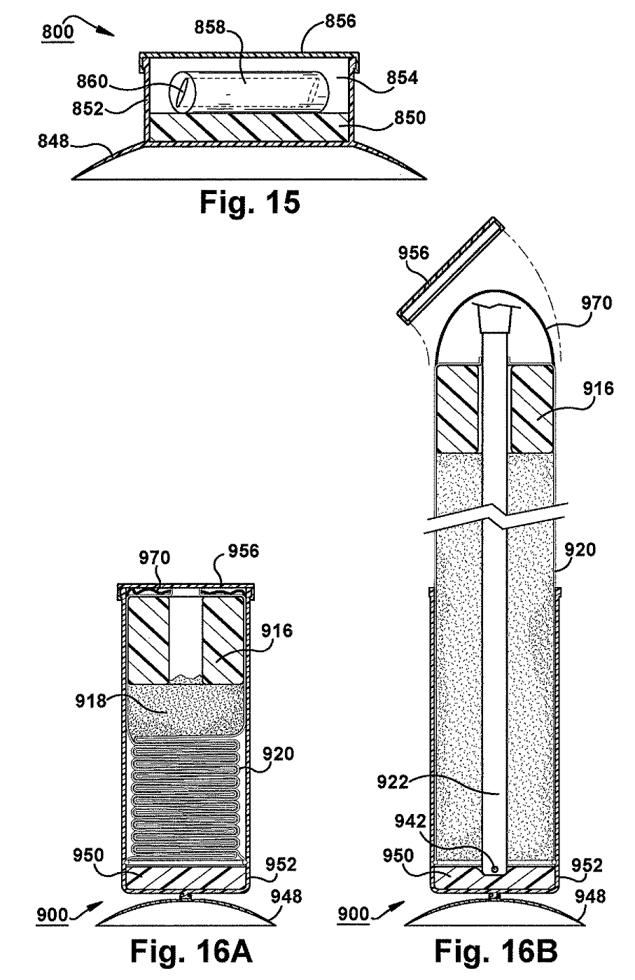

The container 552 creates a reservoir 554 that may be filled with enzymatic detergent. Detergent in the reservoir 554 is suctioned through an opening 542 located toward the distal end of the endoscopic device 522 to clean one or more interior channels. Further, the cleaning device 500 has a suction cup 548 attached to, or integrally molded with (see FIG. 15), the bottom of the container 552. As shown, the suction cup 548 is attached to the container by a center stand-off post. However, any suitable means of attachment known in the art may be used, for example a snap fit, a friction fit, or threads. The suction cup 548 stabilizes the sleeve 520, or collapsible tubing, by anchoring the distal end of the sleeve, such as to a floor or other surface, during insertion or removal of the endoscopic device 522.

FIG. 13 illustrates a cleaning device 600 according to another embodiment of the invention. The cleaning device 600 shown in FIG. 13 has similarities to the cleaning device 500 shown in FIG. 12. However, the container 652 is larger in diameter than the sleeve 620 and has a lid 656. The lid 656 may attach to the container 652 by any suitable means known in the art, such as with threads, friction fit, or snap fit. The lid 656 may be molded and made from any suitable material known in the art, such as polyethylene (PE). The distal end of the sleeve 620 is attached to the lid 656. A hole in the lid 656 allows the endoscopic device 622 to pass through the sleeve 620 and into the container 652.

The larger size of the container 652 creates a larger reservoir 654 that may be filled with enzymatic detergent. Detergent in the reservoir 654 is suctioned through an opening 642 located toward the distal end of the endoscopic device 622 to clean one or more interior channels. Further, the container 652 has a sponge 650, or other soft material such as cloth or foam, lining the bottom of the container. The sponge 650 prohibits damage to the optics at the distal end of the endoscopic device 622, for example during insertion of the endoscopic device into the sleeve 620. In certain embodiments, the container 652 is made from a soft material, such as a thermoplastic elastomer (TPE), and the surface of the container itself prohibits damage to the optics at the distal end of the endoscopic device 622.

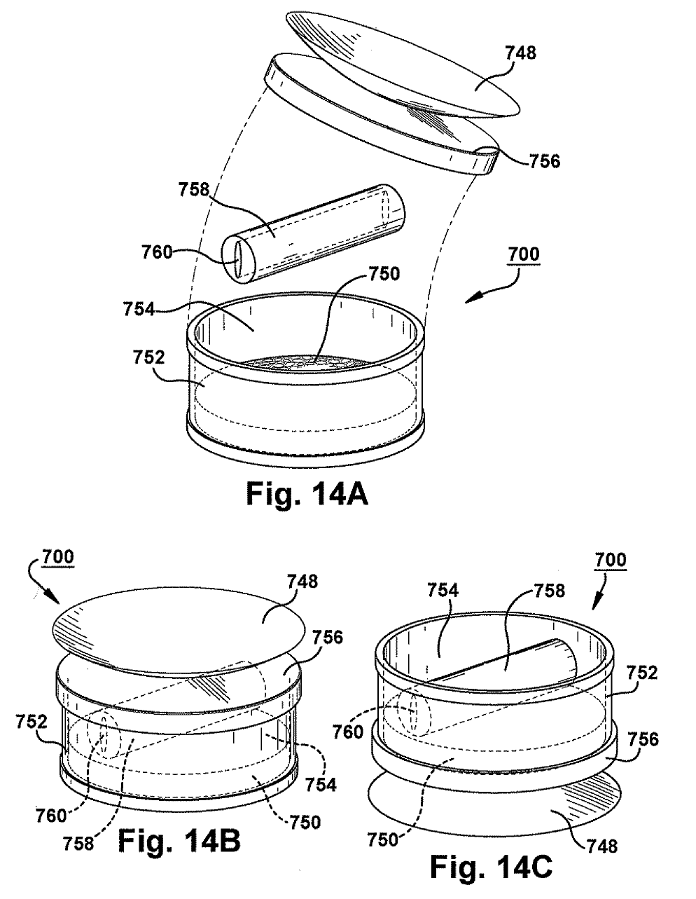

Referring now to FIGS. 14A-14C, cleaning device 700 is depicted which includes a container 752 defining a reservoir 754 that may be filled with enzymatic detergent, a lid 756, a suction cup 748, a sponge 752 lining the bottom of the container 752, and a removable sponge 758. As shown in FIG. 14B, the suction cup 748 is attached to, or integrally molded with (see FIG. 15), the lid 756 of the container 752. The lid 756 may attach to the top or open end of the container 752 by any suitable means known in the art, such as with threads, friction fit, or snap fit. As show in FIG. 14C, the lid 756 may be removed from the open end of the container 752 and attached, or mated, to the bottom or closed end of the container, for example with threads, friction fit, or a snap fit. With the lid 756 and suction cup 748 attached to the bottom of the container 752, the top of the container 752 is left open and the container may be anchored to a surface, such as for example a table or a floor. The suction cup 748 stabilizes the container 752 and prohibits spillage of the enzymatic detergent from the reservoir 754. Further, attaching the lid 756 to the bottom or closed end of the container 752 provides an interim storage location for the lid so that it can be readily located for clean-up and disposal at the end of the procedure. In certain embodiments, the bottom or closed end of the container 752 is a sufficiently wide and stable base such that no suction cup is required to stabilize the container. Further, additional components, such as a dish or skirt, may be used with the container to provide stability and reduce the likelihood of spillage. These components may be reusable and thus not add incremental cost to each cleaning tool sold.

When the distal or insertion end of the endoscopic device is inserted into the container 752, detergent in the reservoir may be suctioned through an opening located toward the distal end of the endoscopic device to clean the interior channels. The sponge 750, or other soft material such as cloth or foam, lining the bottom of the container 752 prohibits damage to the optics at the distal end of the endoscopic device, for example during insertion of the endoscopic device into the container 752. As discussed, container 752 may be made from a soft material, such as a thermoplastic elastomer (TPE), to prohibit damage to the optics at the distal end of the endoscopic device.

The removable sponge 758 is impregnated with enzymatic detergent from the reservoir 754. The removable sponge 758 can be used to clean the outer portions of the endoscopic device, other equipment, or the user's hands. As shown, the removable sponge 758 is cylindrical with a hole 760, or slit, in the center. Portions of the endoscopic device, for example the insertion tube of an endoscope, may be inserted through the hole 760 in the removable sponge 758 to remove debris and contaminants from the exterior of the endoscopic device. However, the removable sponge 758 may be a variety of shapes, sizes, and configurations. For example, in certain embodiments, the removable sponge 758 does not have a hole 760 through the center. In other embodiments, the removable sponge 758 is folded or wrapped. The folded sponge may be unfolded or unwrapped after removal from the cleaning device 700, providing the sponge more surface area for cleaning. Finally, in still other embodiments, the removable sponge is a different material, such as for example, a cloth rag or paper like towel.

FIG. 15 illustrates a cleaning device 800 with some similarity to cleaning device 700 depicted in FIGS. 14A-14C. However, the suction cup 848 is integrally formed with the bottom or closed end of the container 852, similar to a skirt surrounding the bottom edge of the container. It is believed that an integrally formed, or molded, base or suction cup 848 simplifies the fabrication process of the mold for the cleaning device. In this embodiment, the bottom of the suction cup 848 is concave. The suction cup 848 stabilizes the container 852 and prohibits spillage of the enzymatic detergent from the reservoir 854. In some embodiments, a skirt is integrally molded with, or attached to, the bottom of the container to provide a wide and stable base for the container FIGS. 16A-16B illustrate a cleaning device 900 with some similarity to cleaning device 600 depicted in FIG. 13. However, the distal end of the sleeve 920, or collapsible tubing, is attached to the inside bottom of the container 952. In certain embodiments, the distal end of the sleeve 920 may be attached to the sponge 950 lining the bottom of the container 952. Attachment of the sleeve 920 to the inside bottom of the container 952 allows the sleeve to collapse, or compress, into the container for storage and the like. As shown in FIG. 16A, the portion of the sleeve 920 between the cleaning tool 916, or sponge, and the compressed portion of the sleeve creates a reservoir 918 for the enzymatic cleaning fluid. As such, once the lid 956 of the cleaning device 900 is removed, the user may insert the distal or insertion end of the endoscopic device 922 through the hole in the cleaning tool 916 and into the reservoir 918 of cleaning fluid. The cleaning fluid may then be suctioned through an opening 942 in the distal end of the endoscopic device 922 to clean one or more interior channels of the endoscopic device. Once the cleaning fluid is suctioned into the interior channels, the sleeve 920 may then be extended by the user over the remainder of the endoscopic device 922, for example the exterior surface of an endoscope insertion tube. A handle 970, or strap, may be used to extend the sleeve 920 over the endoscopic device 922. As the user extends the sleeve 920 over the endoscopic device 922, any fluid left in the reservoir 918 will coat the interior walls of the sleeve 920, keeping the outer surface of the endoscopic device 922 moist. Further, during the extension of the sleeve, the user may move the cleaning tool 916 of the cleaning device 900 along the endoscopic device 922 to clean debris and contaminants from the exterior surface of the device. As shown in FIG. 16B, once the sleeve 920 is extended, the cleaning device 900 and endoscopic device 922 can be transported and stored for later processing. The handle 970 may be used to store the device 900.

The sleeve 920 of the cleaning device 900 may have an exoskeleton, such as for example a coiled wire, that expands and contracts such that the sleeve may be collapsed, or compressed, inside the container 952 in accordion fashion. The exoskeleton provides structural rigidity to the sleeve 920 making it easier to extend and collapse. The exoskeleton also prohibits the sleeve 920 from drawing down against the endoscopic device 922 when the enzymatic detergent in the reservoir 954 is suctioned through the interior channels of the endoscopic device 922.

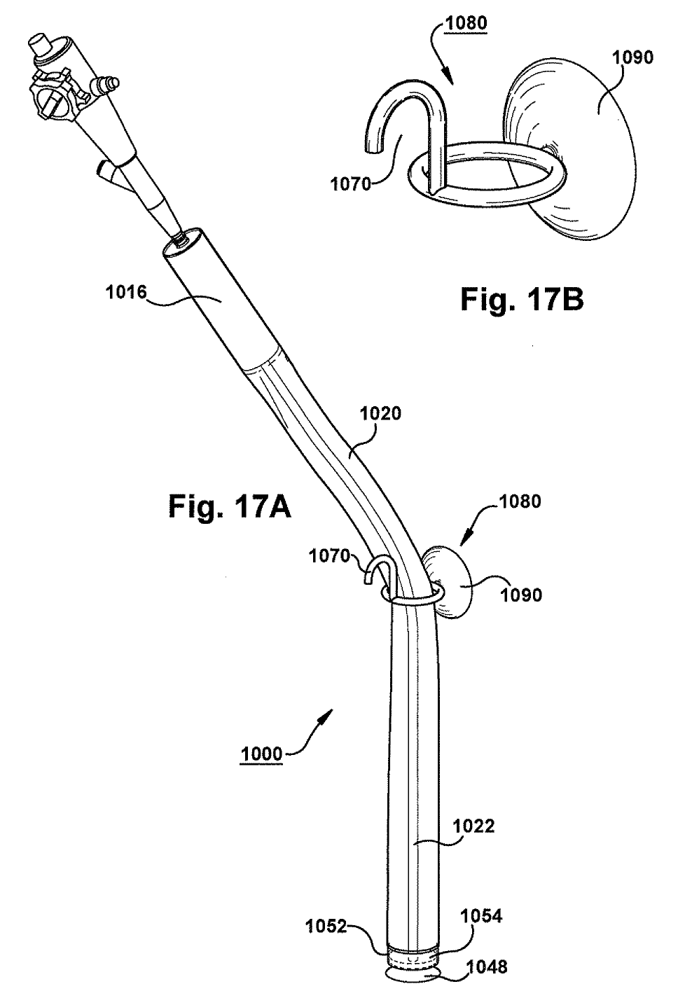

A cleaning device 1000 according to another embodiment of the invention is shown in FIGS. 17A-17B. The cleaning device 1000 includes a mounting component 1080 having a hook portion 1070 and a suction cup 1090. As shown, the sleeve 1020 of the cleaning device 1000 is inserted through a hole in the mounting component 1080. However, in other embodiments, the mounting component 1080 partially surrounds the sleeve 1020 or clips on the sleeve of the cleaning device 1000. The mounting component may also attach to the proximal cleaning tool 1016, or handle, portion of the cleaning device 1000. The hook portion 1070 and suction cup 1090 of the mounting component 1080 allow the mounting component to attach to a cart, a wall, or other structure to provide support to the sleeve in the extended position.

For example, the suction cup 1048 on the bottom of the container 1052 may be attached, or cupped, to the floor while the mounting component 1080 may be attached to a cart by the hook portion 1070 and/or the suction cup 1090. As such, the mounting component 1080 provides an upright/stand up feature for a cleaning device 1000 that may lack the structure to do this independently. In this configuration, the cleaning device 1000 is stabilized such that the user will be able to access the cleaning device 1000 and suction enzymatic detergent from the reservoir 1054 through the channels of the endoscopic device 1022 without the cleaning device being displaced. After the detergent is suctioned through one or more interior channels of the endoscopic device 1022, the mounting component 1080 of the cleaning device 1000 may be removed, or unhooked, from the cart while the suction cup 1048 on the bottom of the container 1052 remains attached, or cupped, to the floor. As such, the user may move the cleaning tool 1016 of the cleaning device 1000 along the endoscopic device 1022, for example the insertion tube of an endoscope, to clean debris and contaminants from the exterior surface of the device. The suction cup 1048 on the bottom of the container 1052 may then be removed from the floor such that the cleaning device 1000 and endoscopic device 1022 can be transported and stored for later processing. The mounting component 1080 described above may be used with any embodiment described herewith.

While several embodiments of the invention have been illustrated and described in considerable detail, the invention is not to be considered limited to the precise constructions disclosed. Various adaptations, modifications and uses of the invention may occur to those skilled in the arts to which the invention relates. It is the intention to cover all such adaptations, modifications and uses falling within the scope or spirit of the specification filed herewith. Further, any feature of an embodiment illustrated or described herewith may used or included in the other embodiments of the invention.

We claim:

1. A device for cleaning an endoscopic device, comprising:
a flexible sleeve having a proximal end and a distal end, wherein the flexible sleeve is movable between a collapsed position and an extended position;
an opening at the proximal end of the flexible sleeve;
a cleaning tool disposed within the flexible sleeve; and
cleaning fluid included within the flexible sleeve.

2. The device of claim 1, wherein with the cleaning device in the collapsed position, the cleaning tool is disposed at the proximal end of the sleeve and the distal end of the sleeve is disposed beyond the cleaning tool, such that a portion of the sleeve between the cleaning tool and the distal end creates a reservoir of cleaning fluid.

3. The device of claim 1, wherein the cleaning tool is a sponge having a hole and impregnated with cleaning fluid, wherein the sponge removes surface debris from the exterior of the endoscopic device as the endoscopic device is inserted through the hole in the sponge.

4. The device of claim 1, wherein the flexible sleeve is transparent such that a user can visually determine the location and cleanliness of the endoscopic device in the sleeve.

5. The device of claim 1 further comprising a strap for anchoring the device during use or storage.

6. The device of claim 1, wherein with the cleaning device in the extended position and the endoscopic device inserted into the flexible sleeve, at least a portion of the interior wall of the sleeve contacts at least a portion of the outer surface of the endoscopic device.

7. The device of claim 1, wherein the flexible sleeve is made from collapsible tubing.

8. The device of claim 1 further comprising a container, wherein said container is sized for housing the endoscopic device.

9. The device of claim 8, wherein the distal end of the sleeve is attached to the interior of the container.

10. The device of claim 8, wherein the container is a flexible transparent bag.

11. The device of claim 8, wherein the device and the endoscopic device are storeable entirely within the container.

12. The device of claim 1 further comprising a second cleaning tool disposed within the flexible sleeve.

13. The device of claim 12, wherein the second cleaning tool is coaxially packed within the cleaning tool and is removable from the device through the opening.

14. The device of claim 12, wherein one of a tab, a string, or a ribbon is attached to the second cleaning tool to facilitate removal of the second cleaning tool through the opening.

15. The device of claim 12, wherein the second cleaning tool is disposed between the cleaning tool and the opening.

16. The device of claim 1 further comprising a container attached to the distal end of the flexible sleeve.

17. The device of claim 16, wherein a suction cup is attached to the container to anchor the distal end of the flexible sleeve.

18. The device of claim 16, wherein the distal end of the flexible sleeve is attached to the interior bottom of the container.

19. The device of claim 16, wherein when the flexible sleeve is in the collapsed position, the flexible sleeve is collapsed within the container.

20. The device of claim 16, wherein a sponge disposed in the container cushions an insertion end of the endoscopic device.

21. The device of claim 16, wherein the distal end of the flexible sleeve is attached to a lid of the container.

22. The device of claim 1 further comprising a container attached to the distal end of the flexible sleeve, wherein a suction cup is attached to the container to anchor the distal end of the sleeve and the sleeve is made from collapsible tubing.

23. The device of claim 1 further comprising a mounting component to stabilize the flexible sleeve when in the extended position.

24. A device for cleaning an endoscopic device, comprising:
a container having an open end and a closed end;
a removable lid attached to the open end of the container;
a suction cup capable of anchoring the container to a surface;
a cleaning tool disposed within the container; and
a cleaning fluid included within the container.

25. The device of claim 24, wherein the suction cup attaches to the lid and the lid is capable of attaching to the closed end of the container.

26. The device of claim 24, wherein the suction cup is integrally formed with the container.

27. A method of using a device to clean an endoscopic device, comprising the steps of:
providing a device comprising a flexible container, wherein the flexible container is movable between a collapsed position and an extended position, an opening in the flexible container, a cleaning tool disposed within the flexible container, and cleaning fluid included within the flexible container;
extending the flexible container, wherein at least a portion of an interior wall of the flexible container is coated with cleaning fluid as the flexible container is extended;
inserting the endoscopic device through the opening and the cleaning tool and into the flexible container; and
removing surface debris from the endoscopic device as the endoscopic device is inserted through the cleaning tool.

28. The method of claim 27, wherein at least a portion of the cleaning fluid coating the at least a portion of the interior wall of the flexible container transfers to the endoscopic device and prohibits the endoscopic device from drying out during transport and storage.

29. The method of claim 27, wherein with the device in the collapsed position, the cleaning tool is disposed at a proximal end of the container and a distal end of the container is disposed beyond the cleaning tool such that a portion of the container between the cleaning tool and the distal end creates a reservoir of cleaning fluid.

30. The method of claim 29 further comprising inserting an insertion end of the endoscopic device into the reservoir and suctioning cleaning fluid through an opening in a distal end of the endoscopic device.

31. The method of claim 27, farther comprising removing surface debris from the endoscopic device as the endoscopic device is withdrawn from the device and leaving debris inside the flexible container.

32. The method of claim 27 further comprising expelling from an interior channel of the endoscopic device cleaning fluid into the flexible container prior to removal of the endoscopic device from the device.
